(19) United States
(12) Patent Application Publication
(10) Pub. No.: US 2019/0107652 A1
(43) Pub. Date: Apr. 11, 2019

(54) Fluid Filled, Variable Magnification Lens

(71) Applicant: Jackson Richard Catalano, Ladera Ranch, CA (US)

(72) Inventor: Jackson Richard Catalano, Ladera Ranch, CA (US)

(21) Appl. No.: 15/727,587

(22) Filed: Oct. 7, 2017

(51) Int. Cl. G02B 3/14

(52) U.S. Cl. CPC G02B 3/14

(57) ABSTRACT

The newly created device outlined above is a fluid filled, optical lens able to change its magnification depending on the pressure of the fluid contained in the lens. This device has few moving parts, decreasing the cost and/or complexity of repair and manufacture. The device is so simple it can be created in the average household with common materials. Since the lens has its own magnification control, it doesn't need a separate assembly for magnification control. This both reduces the complexity and maintenance needed for any optical instrument the lens is installed in.

### CROSS-REFERENCE TO RELATED APPLICATIONS

Not Applicable

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

This Invention is targeted towards the field of optics.

Before the invention of this device, lenses used in optical instruments were usually solid glass or acrylic, leaving no flexibility for the magnification of said optical instruments to be changed without the addition of a specialized set of magnification lenses that can allow for the magnification to be changed. While, flexible lenses that are able to change their magnification have been proposed, these lenses are made of water droplets that cannot be successfully scaled up to a reasonable degree.

### BRIEF SUMMARY OF THE INVENTION

This lens uses the movement of fluid to change shape and thus magnification at will. It can change the magnification of objects using only itself and does not need a separate magnification assembly. It is also incredibly simple and has no moving parts allowing for minimal maintenance, simple manufacture (to the point that one could be made with household materials) and simple replacement.

### BRIEF DESCRIPTION OF THE SEVERAL VIEWS OF THE DRAWING

FIG. 1: Front View of Device and Front View of Plunger assembly

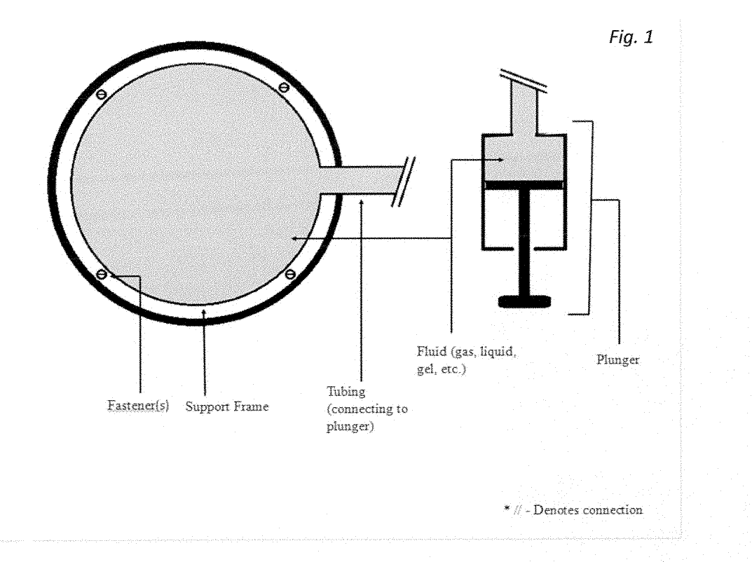

FIG. 2: Side View of Device

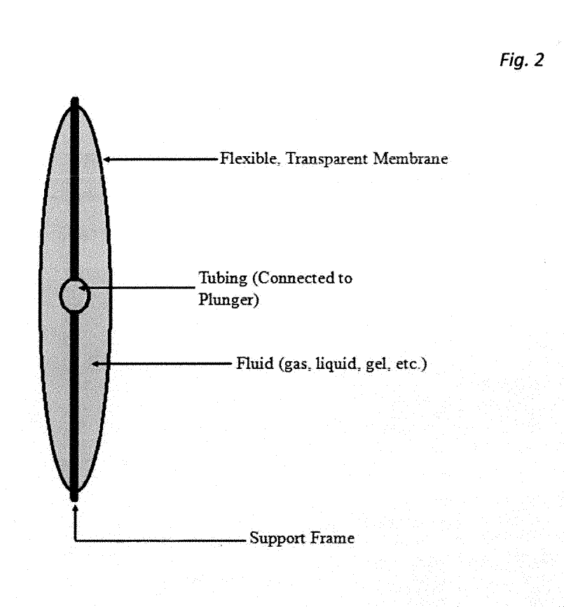

FIG. 3: Exploded View of Device

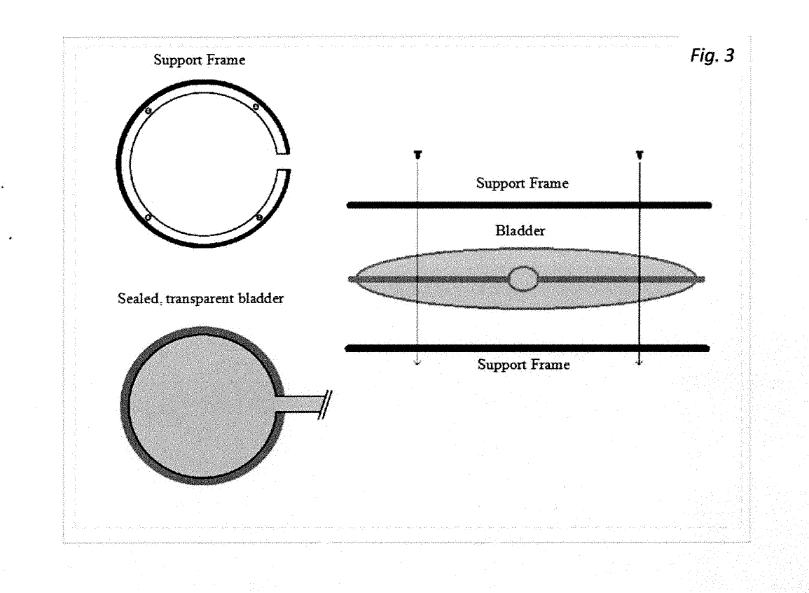

### DETAILED DESCRIPTION OF THE INVENTION

### Theory of Operation

The device shown above makes use of the pressure a fluid (Fluid) exerts on the flexible walls (Flexible, Transparent Membrane) of its container (Bladder) to cause the walls to bulge to different degrees depending on the pressure applied to said fluid. The fluid contained in the bladder acts as an optical lens. As the walls bulge to different degrees, the shape of the lens changes, and thus the magnification of the lens changes as well. Fluid pressure can be controlled via the plunger (Plunger). In this manner, by utilizing the plunger as a control, the magnification of the lens device can be controlled on the fly.

### Construction of the Device

The flexible bladder (Bladder) consists of clear rubber or flexible plastic. The support frame (Support Frame) consists of stiff plastic (pvc, vinyl), wood, metal, or practically any other nonflexible material. The tubing connecting the bladder to the plunger (Tubing) consists of surgical tubing or any other flexible plastic tubing. The plunger assembly (Plunger) consists of stiff plastic with a rubber ring surrounding the head of the piston to maintain an adequate seal.

### Detailed Assembly

This device can be assembled by sealing two layers of thin plastic together with a circular heat seal. The tubing can either be part of this sealed bladder or be connected with sealant later on. The sealed rim of the bladder is then sandwiched between two stiff, plastic support frames held in place with bolts. The tubing can then be attached to a separately assembled or purchased plunger. The bladder can then be filled with a clear fluid of choice, preferably alcohol or water.

1. A magnification lens consisting of: a fluid filled bladder or bag that bulges to create a lens.

2. A magnification lens consisting of: a control system that changes the pressure of fluid inside the bladder increasing or decreasing the bulging of the membrane

3. A magnification lens consisting of: fluid containment using a plastic membrane as opposed to solely surface tension

4. A magnification lens consisting of: a lens able to change its magnification using changing fluid pressure
